(19) United States
(12) Patent Application Publication
(10) Pub. No.: US 2011/0041574 A1
(43) Pub. Date: Feb. 24, 2011

(54) COMBINATION LOCK WITH DUAL KEY NUMBERS

(76) Inventor: KUO-TSUNG YANG, Taipei City (TW)

Correspondence Address: KILE PARK GOEKJIAN REED & MCMANUS, 1200 NEW HAMPSHIRE AVE, NW, SUITE 570, WASHINGTON, DC, 20036, US

(21) Appl. No.: 12/545,860

(22) Filed: Aug. 23, 2009

(51) Int. Cl. E05B 37/00

(52) U.S. Cl. 70/315

(57) ABSTRACT

A combination lock with dual key numbers includes a casing, a latch, a locking piece and a plurality of restricting assemblies. The latch is slidingly provided in the casing, and the locking piece is pivotally provided in the casing. The latch has an abutting portion and a plurality of protrusions. The locking piece has a plurality of locking grooves. The restricting assemblies are rotatably provided outside the latch. Each of the restricting assemblies comprises a restricting piece, a first braking piece and a second braking piece. The first braking piece and the second braking piece are restricted by the restricting piece. The second braking piece has a guiding slot corresponding to the protrusion. With the relative rotation among the restricting piece, the first and second braking pieces, a user can set two independent groups of key numbers, which can unlock the combination lock, thereby increasing the convenience in use.

### BACKGROUND OF THE INVENTION

1. Field of the Invention

The present invention relates to a combination lock with dual key numbers, and in particular to a lock capable of setting an unlocked state or a locked state by key numbers.

2. Description of Related Art

People often use a combination lock to prevent thief from opening their coffers to steal personal articles or entering a private place. For example, the coffer in a public place or personal strongbox is provided with a combination lock on its body to prevent other person to open the coffer or strongbox with a bad intension. Further, the chain in a bicycle or motorcycle is locked by a combination lock to protect against thieves. Moreover, the door in a private place such as a house or office is provided with a combination lock to prevent from improper access of other people. Accordingly, a user can set a group of key numbers to lock/unlock the combination lock, thereby preventing other people from opening the coffer/strongbox to steal personal articles or entering a private place.

However, the conventional combination lock has only one set of key number. If the user forgets this set of key numbers, the user cannot use this combination lock any more, which makes the usage of the combination lock inconvenient.

In order to overcome the above problems, the present Inventor proposes a novel and reasonable structure based on his delicate researches and expert experiences.

### SUMMARY OF THE INVENTION

The objective of the present invention is to provide a combination lock with dual key numbers. With the relative rotation among a restricting piece, a first braking piece and a second braking piece, the user can set two independent groups of key numbers. Each group of key numbers can unlock the combination lock, which increases the convenience in use.

The present invention provides a combination lock with dual key numbers, which includes: a casing having a plurality of stoppers; a latch slidingly provided in the casing, the latch having an abutting portion and a plurality of protrusions; a locking piece pivotally provided in the casing, the locking piece having a plurality of locking grooves corresponding to the abutting portion; and a plurality of restricting assemblies, each of the restricting assemblies having a restricting piece, a first braking piece and a second braking piece, the first braking piece and the second braking piece being restricted by the restricting piece, the second braking piece having a guiding slot corresponding to the protrusion, the second braking piece corresponding to the stopper.

The present invention has advantageous features as follows:

(I) Each of the restricting assemblies comprises a restricting piece, a first braking piece and a second braking piece. The restricting piece sheathes the first braking piece, and the first braking piece sheathes the second braking piece. With the relative rotation among the restricting piece, the first braking piece and the second braking piece, the user can set two independent groups of key numbers, which increases the convenience in use.

(II) The second braking piece is able to slide with respect to the stopper to form an unlocked state, and the protrusion is inserted into the guiding slot to form another unlocked state. As a result, the combination lock with dual key numbers according to the present invention has two independent groups of key numbers for two different unlocked states which increases the convenience in use.

In order to further understand the characteristics and technical contents of the present invention, a description relating thereto will be made with reference to the accompanying drawings. However, the drawings are illustrative only but not used to limit the present invention.

### BRIEF DESCRIPTION OF THE DRAWINGS

FIG. 1 is a perspective view showing the combination lock with dual key numbers according to the present invention;

FIG. 2 is a partially perspective view showing the combination lock with dual key numbers according to the present invention;

FIG. 2A is a perspective view showing the second braking piece of the present invention;

FIG. 3 is a cross-sectional view showing the combination lock with dual key numbers according to the present invention being set in the first group of key numbers;

FIG. 4 is a cross-sectional view showing the combination lock with dual key numbers according to the present invention being set in the second group of key numbers;

FIG. 5 is a partially perspective view showing the unlocked state of the combination lock with dual key numbers according to the present invention;

FIG. 6 is a partially perspective view showing another unlocked state of the combination lock with dual key numbers according to the present invention; and

FIG. 7 is a partially cross-sectional view showing the combination lock with dual key numbers according to the present invention.

### DETAILED DESCRIPTION OF THE PREFERRED EMBODIMENTS

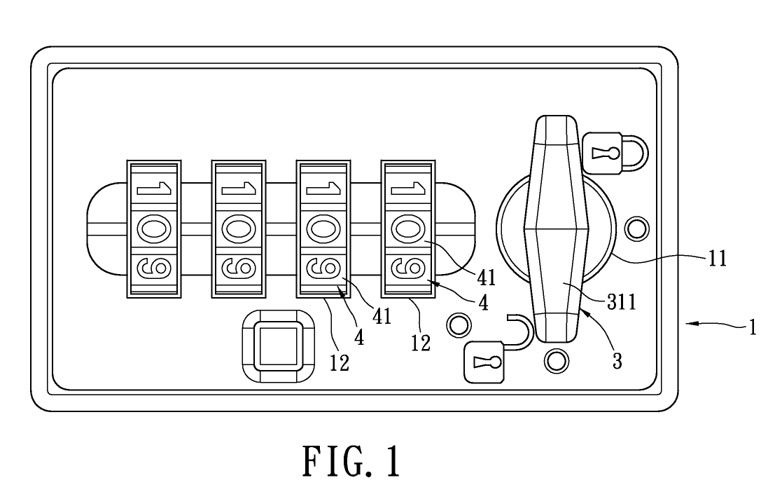

Please refer to FIGS. 1, 2, 2A and 3. The present invention provides a combination lock with dual key numbers, which includes a casing 1, a latch 2, a locking piece 3, four restricting assemblies 4 and two elastic pieces 5.

The casing 1 is a hollow casing, in which the latch 2, the locking piece 3, the restricting assemblies 4 and the elastic pieces 5 are provided. The top surface of the casing 1 is provided with a first notch 11 and a plurality of second notches 12. The interior of the casing 1 is provided with a plurality of stoppers 13. The top of the locking piece 3 penetrates the first notch 11 to be exposed beyond the casing 1, so that a user can rotate the locking piece 3. Each of the restricting assemblies 4 corresponds to a second notch 12 respectively. The restricting assembly 4 partially protrudes from the second notch 12 to be exposed beyond the casing 1, so that the user can poke the restricting assembly 4. With the above arrangement, the user rotates the locking piece 3 to switch the modes of the combination lock such as setting a first group of key numbers, setting a second group of key numbers, an unlocked state, a locked state or the like. When the restricting assemblies 4 are poked respectively to the predetermined first group of key numbers or second group of key numbers, the locking piece 3 can rotate to unlock the combination lock.

The latch 2 is slidingly provided in the casing 1, so that the latch 2 can slide within the casing 1. The latch 2 is formed into a rod. One end of the latch 2 penetrates the restricting assembly 4, and the other end thereof has an abutting portion 21. The abutting portion 21 abuts the locking piece 3. The outer edge of the latch 2 is provided with a plurality of protrusions 22.

The locking piece 3 is pivotally connected in the casing 1, and it is rotatable in the casing 1. The locking piece 3 comprises a locking body 31 and a tongue 32. The top of the locking body 31 extends to form a rotating portion 311, and the bottom of the locking body 31 extends to form a pivoting portion 312. The pivoting portion 312 is pivotally connected in the casing 1. The outer edge of the locking body 31 is provided with a plurality of locking grooves 313. The size and shape of the locking groove 313 correspond to those of the abutting portion 21, so that the abutting portion 21 can be inserted into the locking groove 313. The tongue 32 is connected to the pivoting portion 312. When an external force is applied to the rotating portion 311, the locking body 31 is driven to rotate in the casing 1. As a result, the tongue 32 is driven to move, thereby unlocking the combination lock. When the abutting portion 21 is inserted into the locking groove 313, the latch 2 locks the locking piece 3, so that the latch 2 cannot rotate and the tongue 32 cannot move any more. Thus, the combination lock is locked.

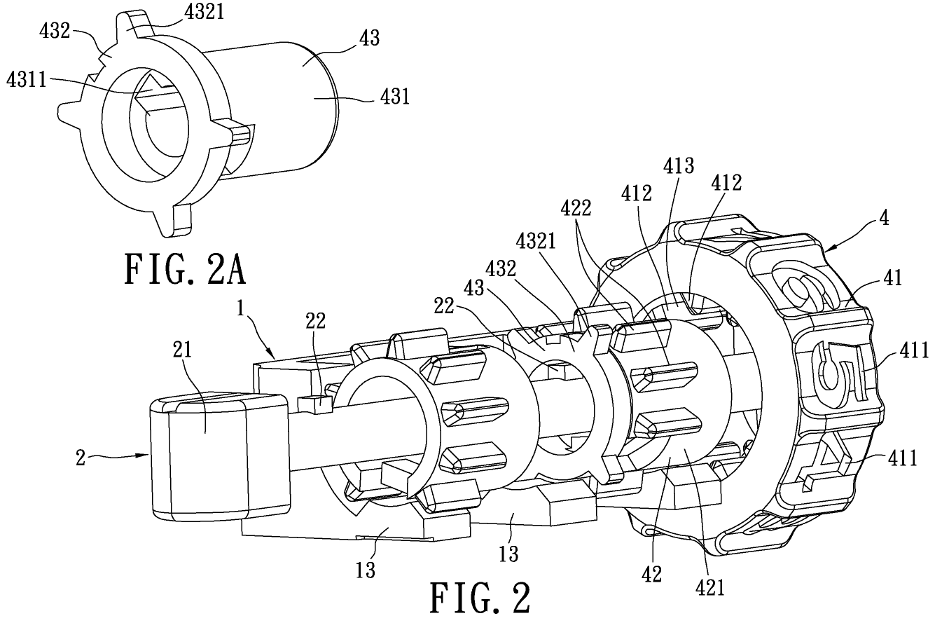

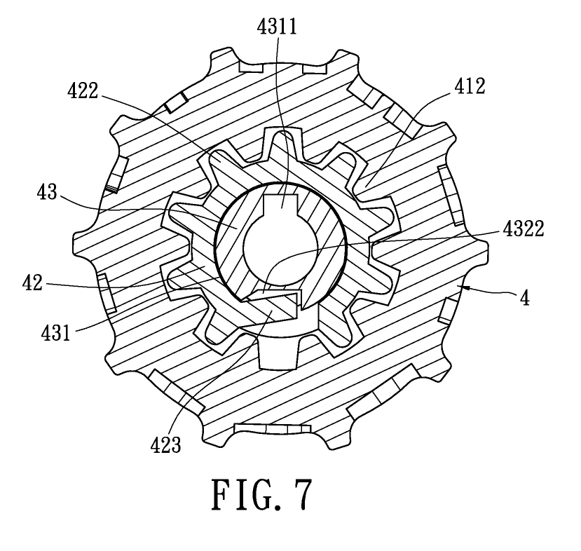

The restricting assemblies 4 surround the periphery of the latch 2 at intervals. Each of the restricting assemblies 4 comprises a restricting piece 41, a first braking piece 42 and a second braking piece 43. The first braking piece 42 and the second braking piece 43 are restricted by the restricting piece 41. The restricting piece 41 is formed into a ring with its outer edge having a plurality of poking portions 411 at intervals. The surface of each of the poking portions 411 is scribed with a number for identification. The inner edge of the restricting piece 41 is provided with a plurality of restricting flanges 412 at intervals. A restricting slot 413 is defined between each restricting flange 412 and an adjacent restricting flange 412. The first braking piece 42 is located in the restricting piece 41. The first braking piece 42 has a first braking body 421, a plurality of first braking portions 422 and a number-searching flange 423 (FIGS. 2 and 7). The first braking body 421 is a hollow cylinder. One end of the first braking body 421 is inserted into the restricting piece 41, and the outer edge of the other end of the first braking body 421 is provided with the first braking portions 422 at intervals. The size and shape of the first braking portions 422 correspond to those of the restricting slots 413 respectively. One end of the number-searching flange 423 is connected to the first braking body 421, and the other end thereof extends toward the interior of the first braking piece 42. The second braking piece 43 is located within the first braking piece 42. The second braking piece 43 has a second braking body 431 and a base 432. One end of the second braking body 431 is inserted into the first braking piece 42, and the other end thereof extends to form the base 432. The second braking body 431 is integrally formed with the base 432. The second braking body 431 is a hollow cylinder. The inner edge of the second braking body 431 is provided with a guiding slot 4311. The outer edge of the second braking body 431 is provided with a number-searching trough 4321. The size and shape of the guiding slot 4311 correspond to those of the protrusion 22. The base 432 is formed into an annular body. The outer edge of the base 432 is provided with a plurality of second braking portions 4321 at intervals. The size and shape of the second braking portion 4321 correspond to those of the restricting slot 413. The interval between the two second braking portions 4321 corresponds to the size of the stopper 13 of the casing 1.

With the above arrangement, the latch 2 penetrates the second braking piece 43, and the second braking piece 43 is inserted into the first braking piece 42. Further, the first braking piece 42 is inserted into the restricting piece 41 with the restricting piece 41 being rotatably disposed outside the latch 2. When an external force is applied to poke the poking portions 411 of the restricting piece 41, the restricting piece 41 rotates around the axial center of the latch 2. The first braking portion 422 of the first braking piece 42 and the second braking portion 4321 of the second braking piece 43 are inserted into the restricting slot 413 of the restricting piece 41. Further, when the first braking portion 422 and the second braking portion 4321 are inserted into the restricting slot 413, the first braking piece 42 and the second braking piece 43 are restricted by the restricting piece 41 respectively. The rotation of the restricting piece 41 causes the first braking piece 42 and the second braking piece 43 to rotate accordingly. Although there are four restricting assemblies 4 in the present invention, the number of the restricting assemblies 4 can be increased or decreased according to practical demands. For example, the number of the restricting assemblies 4 can be increased to five, six or more, thereby increasing the complexity of key numbers. Thus, the key numbers of the combination lock of the present invention cannot be solved easily.

An elastic piece 5 is provided between the second braking piece 43 and the latch 2. One end of the elastic piece 5 abuts the second braking body 431 of the second braking piece 43, and the other end thereof abuts the abutting portion 21 of the latch 2, so that the abutting portion 21 abuts the locking piece 3. Moreover, another elastic piece 5 is provided between the first braking piece 42 and the casing 1 for returning the first braking piece 42 back to its original position.

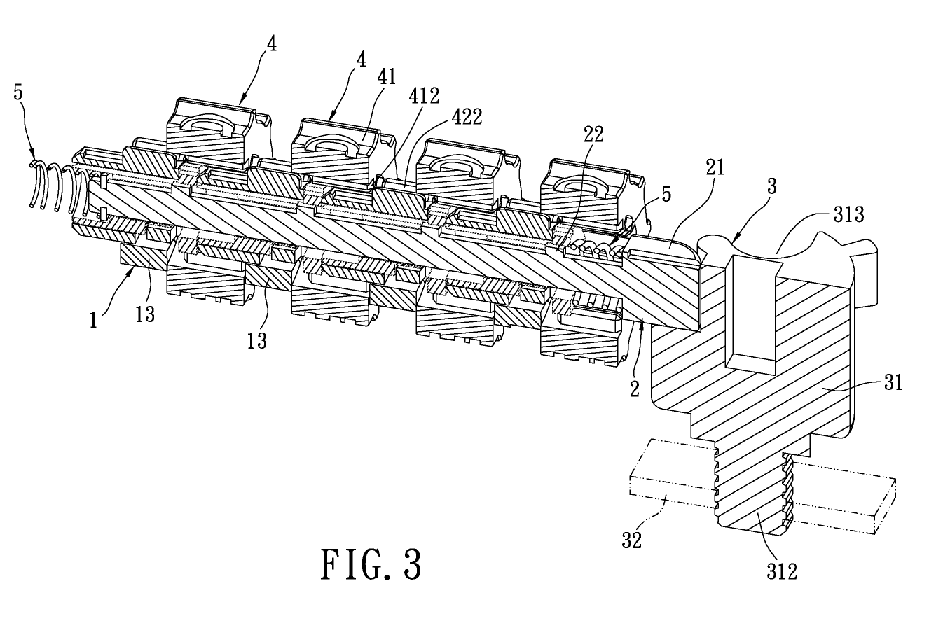

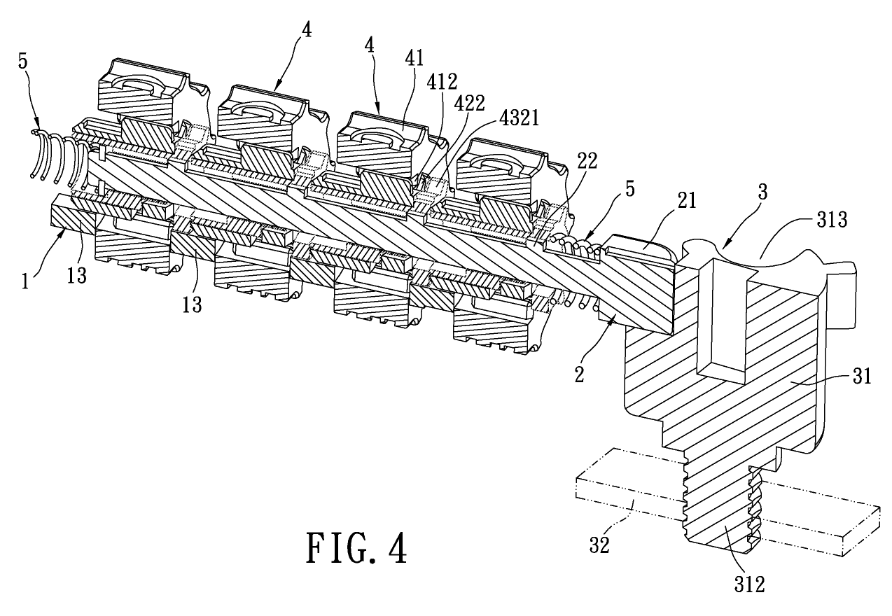

The user can set two independent groups of key numbers. In order to set a first group of key numbers, the user rotates the locking piece 3 to remove the first braking portion 422 from the restricting slot 413 (FIG. 3). At this time, the user can poke each of the restricting pieces 41 to rotate so as to set the first group of key numbers. Then, the user can rotate the locking piece 3 to remove the second braking piece 4321 from the restricting slot 413 (FIG. 4). At this time, the user can poke each of the restricting pieces 41 to rotate, thereby setting the second group of key numbers. Accordingly, the user can set two independent groups of key numbers, and both groups of key numbers can unlock the combination lock. For example, an administrator can set a first group of key numbers by himself, and a common user can set a second group of key numbers. In general cases, the common user can unlock the combination lock by means of the second group of key numbers set by him/her. In a special case that, for example, the common user forgets the second group of key numbers, the only way to unlock the combination lock for the administrator is to use the first group of key numbers set by the administrator.

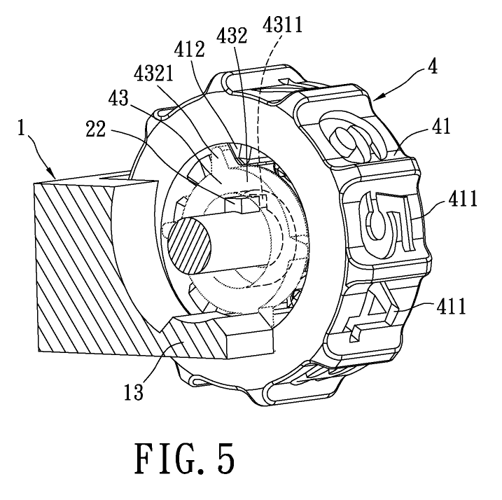

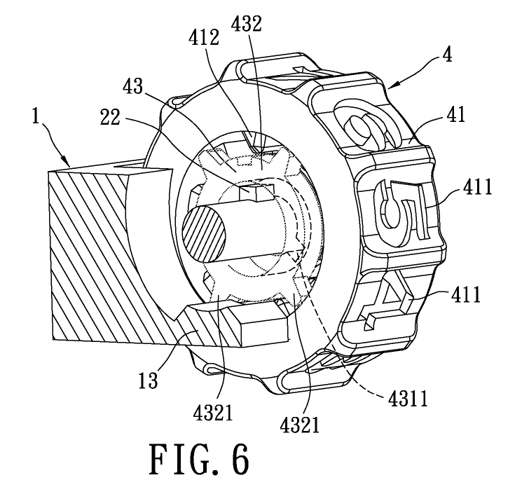

Therefore, when the restricting pieces 41 are not poked to the predetermined first group of key numbers or the second group of key numbers, the guiding slots 4311 of the rotating second braking piece 43 does not correspond to the protrusion 22 of the latch 2, so that the protrusion 22 abuts the second braking body 431. At this time, the interval between two of the second braking portions 4321 of the rotating second braking piece 43 also does not correspond to the stopper 13 of the casing 1, so that the second braking portion 4321 abuts the stopper 13. As a result, each of the second braking pieces 43 abuts a stopper 13 respectively, so that the latch 2 cannot slide. The latch 2 locks the locking piece 3, so that the locking piece 3 cannot rotate any more so as to form a locked state. When the restricting pieces 41 are poked to the predetermined first group of key numbers (FIG. 5), the guiding slot 4311 of the rotating second braking piece 43 corresponds to the protrusion 22 of the latch 2. The protrusion 22 is inserted into the guiding slot 4311, and the latch 2 extends into the second braking piece 43, so that the latch 2 can slide with respect to the restricting piece 41. The abutting portion 21 is removed from the locking groove 313, so that the locking piece 3 can rotate again so as to form a first unlocked state. Further, when the restricting pieces 41 are poked to the predetermined second group of key numbers (FIG. 6), the interval between two of the second braking portions 4321 of the rotating second braking piece 43 corresponds to the stopper 13 of the casing 1. Thus, the stopper 13 is inserted into two second braking portions 4321, and the second braking piece 43 can slide with respect to the stopper 13. As a result, the latch 2 can slide with respect to the restricting piece 41, so that the abutting portion 21 is removed from the locking groove 313. Accordingly, the locking piece 3 can rotate to form a second unlocked state. With this arrangement, the latch 2 slides with respect to the restricting piece 41 to form the first unlocked state or the second unlocked state. The abutting portion 21 is removed from the locking groove 313, so that the locking piece 3 can rotate again to move the tongue 32, thereby unlocking the combination lock.

When the administrator intends to open the combination lock with dual key numbers, the administrator can search the key numbers preset by the common user. Please refer to FIG. 7. The administrator rotates the restricting assemblies 4 to rotate the first braking piece 42 with respect to the second braking piece 43. When the number-searching flange 423 is engaged with the number-searching trough 4322, the key numbers preset by the common user can be found out, thereby preventing the inconvenient situation caused by the forgetting of the key numbers preset by the common user.

According to the above, the present invention has advantageous features as follows:

(I) Each of the restricting assemblies 4 comprises a restricting piece 41, a first braking piece 42 and a second braking piece 43. The restricting piece 41 sheathes the first braking piece 42, and the first braking piece 42 sheathes the second braking piece 43. With the relative rotation among the restricting piece 41, the first braking piece 42 and the second braking piece 43, the user can set two independent groups of key numbers, which increases the convenience in use.

(II) The stopper 13 is inserted into two second braking portions 4321, so that the second braking piece 43 is able to slide with respect to the stopper 13 to form an unlocked state, and the protrusion 22 is inserted into the guiding slot 4311 to form another unlocked state. As a result, the combination lock with dual key numbers according to the present invention has two independent groups of key numbers for two different unlocked states, which increases the convenience in use.

(III) With the number-searching flanges 423 being engaged with the number-searching troughs 4322, the key numbers preset by the user can be found out, which increases the convenience in use.

The above-mentioned descriptions represent merely the preferred embodiments of the present invention, without any intention to limit the scope of the present invention thereto. Various equivalent changes, alternations or modifications based on the claims of present invention are all consequently viewed as being embraced by the scope of the present invention.

What is claimed is:

1. A combination lock with dual key numbers, comprising:
a casing having a plurality of stoppers;
a latch slidingly provided in the casing, the latch having an abutting portion and a plurality of protrusions;
a locking piece pivotally provided in the casing, the locking piece having a plurality of locking grooves corresponding to the abutting portions respectively; and
a plurality of restricting assemblies, each of the restricting assemblies having a restricting piece, a first braking piece and a second braking piece, the first braking piece and the second braking piece being restricted by the restricting piece, the second braking piece having a guiding slot corresponding to the protrusion, the second braking piece corresponding to the stopper.

2. The combination lock with dual key numbers according to claim 1, wherein the restricting assemblies, the latch and the locking piece are provided in the casing, the casing is provided with a first notch and a plurality of second notches, a top of the locking piece penetrates the first notch to be exposed outside the casing, each of the restricting assemblies corresponds to one of the second notches, the restricting assembly partially protrudes from the second notch to be exposed outside the casing.

3. The combination lock with dual key numbers according to claim 1, wherein the latch penetrates the second braking piece, the second braking piece is inserted into the first braking piece, the first braking piece is inserted into the restricting piece, the restricting piece is rotatably provided outside the latch.

4. The combination lock with dual key numbers according to claim 1, wherein the restricting piece is provided with a plurality of restricting flanges, a restricting slot is defined between every adjacent two of the restricting flanges, the first braking piece is provided with a plurality of first braking portions, the second braking piece is provided with a plurality of second braking portions, the first braking portions and the second braking portions correspond to the restricting slots.

5. The combination lock with dual key numbers according to claim 4, wherein the first braking portion is inserted into the restricting slot, the second braking portion is inserted into the restricting slot.

6. The combination lock with dual key numbers according to claim 4, wherein the protrusion abuts the second braking piece, each of the second braking pieces abuts one of the stoppers.

7. The combination lock with dual key numbers according to claim 1, wherein an elastic piece is provided between the second braking piece and the abutting portion, one end of the elastic piece abuts the second braking piece, the other end of the elastic piece abuts the abutting portion, the abutting portion is inserted into the locking groove, the latch locks the locking piece.

8. The combination lock with dual key numbers according to claim 7, wherein another elastic piece is provided between the first braking piece and the casing.

9. The combination lock with dual key numbers according to claim 7, wherein the protrusion is inserted into the guiding slot, the latch slides with respect to the restricting piece, the abutting portion is removed form the locking groove.

10. The combination lock with dual key numbers according to claim 7, wherein the stopper is inserted into two of the second braking portions, the second braking pieces slide with respect to the stopper, the latch slides with respect to the restricting piece, the abutting portion is removed from the locking groove.

11. The combination lock with dual key numbers according to claim 1, wherein the locking piece is connected to a tongue.

12. The combination lock with dual key numbers according to claim 1, wherein the first braking piece further comprises a number-searching flange, the second braking piece further comprises a number-searching trough, the number-searching flange is engaged with the number-searching trough.
